(19) United States
(12) Patent Application Publication
(10) Pub. No.: US 2017/0193417 A1
(43) Pub. Date: Jul. 6, 2017

(54) OPTIMIZATION OF INVENTORY AND ASSET SELECTION

(71) Applicant: ALI SYED, Islamabad (PK)

(72) Inventor: ALI SYED, Islamabad (PK)

(21) Appl. No.: 14/988,577

(22) Filed: Jan. 5, 2016

(51) Int. Cl. G06Q 10/06; G06Q 30/06; G06Q 10/08

(52) U.S. Cl. CPC G06Q 10/06315; G06Q 10/087; G06Q 30/0645

(57) ABSTRACT

A system and method for an asset management system with the ability to optimize inventory and asset selection. The management system can receive asset record creation requests which can be stored in an asset database. User devices may be accessed to execute an asset management application and/or program to run the asset management service within the system and perform the aforementioned tasks. The user devices may also be utilized by executing an asset management application and/or program to scan and/or select asset to be checked out. Optimization of inventory is ensured by specifying event and/or action data with regards to asset utilization and performance. Status updates may be provided to the asset management service for updating asset records.

### BACKGROUND

The disclosure presented herein relates to methods, system and computer program products relating to tracking and managing assets such as medical equipment, office furniture and/or inventory, manufacturing inventory, rental equipment etc. More particularly, it relates to the optimization of inventory and selecting assets for rentals, enterprise resource planning, assignments, and the like, based on criteria, including but not limited to, consumer relevance, usage history, depreciation etc. in conjunction with company requirements to achieve certain usage patterns for assets, like uniform usage of all assets, minimized wear-tear, utilization of least recently used asset, usage based on procurement dates, or expected maintenance dates and the like, etc.

Often physical assets (buildings, infrastructure and equipment) form a significant proportion of the total assets of an organization. Especially capital intensive industries like healthcare, real estate, construction and manufacturing industries face the harsh realities of operating in highly competitive markets and dealing with high value assets and equipment where each misplacement, loss and/or failure is disruptive and costly. Thus it is important for organizations to maximize the return on investment from their asset base.

Asset and inventory management is essential to an organization's effective overall performance. An example can be with the purchase of a large number of equipment, including, but not limited to, office furniture, stationery containing equipment, computer terminals and peripheral devices. There is an ever growing need to keep track of these assets as the size of a company increases. Another example is managing stock of items in different warehouses and office shelves.

Managing assets is equally challenging for rental organizations or even departments within organizations that need to track and manage equipment, inventory, machinery and human resource based assets, which may be remotely located. There is an increasing demand for asset management systems that enable the geographically scattered organizations of today. Moreover, with the diversified needs, there is also a requirement for optimal usage of the assets.

Conventional asset tracking and/or management systems, while providing for inventory optimization for warehouses, do not account for the optimization of asset assignments or inventory selection for utilizing within the organization (enterprise resource planning) and/or rental systems that require auto selection of assets or inventory to ensure achieving certain goals like uniform usage of equipment, weather based equipment preference and/or matching customer history to asset quality for maximum return on investment.

### SUMMARY

Disclosed herein are systems and methods for an asset management system that provides for optimization of inventory and asset selection, while also ensuring utilization of the assets efficiently. In some embodiments customers may provide requirements for an asset, data is input via the online interface and the system provides asset and inventory records. These embodiments may enhance the utilization of asset inventory by considering the factors of, among others, availability, asset utilization strategy, depreciation of an asset and user relevance in addition to the requirements as specified by the customers.

Many embodiments may have application to a wide range of industries including the following: automotive rentals and sales, computer hardware and software rentals, manufacturing and sales, telecommunications sales and manufacturing, medical and pharmaceutical rental, sales and manufacturing, and construction industries. For example, in the auto rental industry, embodiments of the inventory search engine can be used to provide auto rental business inventory information to a user. Auto rental is an example of an industry that generally maintains real-time or near real-time inventory data. For example and without limitation, upon renting a vehicle in the past a customer might want to rent the same vehicle. Upon providing preference to the rental business, the data may be entered into the online interface of the system. The users may be provided with the vehicles that correspond to their requirements by matching their input, depreciation of the automobiles that conform to the customer classification, availability, even utilization of the multiplicity of an asset, depreciation of an asset and user relevance. The preferences with regards to utilization of all assets vis-à-vis multiplicities and therefore ensuring optimization of inventory and asset selection can be set by user input for each asset, either individually or as a group.

The construction and method of operation of the present disclosure, however, together with additional objectives and advantages thereof will be best understood from the following description of specific embodiments when read in connection with the accompanying drawings and claims.

### BRIEF DESCRIPTION OF THE DRAWINGS

FIG. 1 shows a functional block diagram of a client server system.

FIG. 2 shows certain aspects of an operating environment for the technologies and embodiments disclosed herein illustrated for inventory optimization and asset selection in an asset management system.

FIG. 3 illustrates of an example embodiment for the online interface method 300 according to the present disclosure.

FIG. 4 illustrates certain the aspects of the current disclosure for creating asset information for a system.

FIG. 5 shows a process illustrating certain aspects of updating asset information for inventory optimization for an asset management system.

FIG. 6 shows a process which depicts optimization of inventory for asset selection based on the current disclosure.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

The term “structured data source” generally includes databases, XML files, ordered text files and other structures to design to store and retrieve data.

The word “Middleware” generally means computer software that connects software components or applications. The software consists of a set of enabling services that allow multiple processes running on one or more machines to interact across a network. Middleware conventionally provides for interoperability in support of complex, distributed applications. It often includes web servers, application servers, and similar tools that support application development and delivery such as XML, SOAP, and service-oriented architecture.

The term “virtual machine” or “VM” generally refers to a self-contained operating environment that behaves as if it is a separate computer even though is is part of a separate computer or may be virtualized using resources form multiple computers.

The acronym “XML” generally refers to the Extensible Markup Language. It is a general-purpose specification for creating custom markup languages. It is classified as an extensible language because it allows its users to define their own elements. Its primary purpose is to help information systems share structured data, particularly via the Internet, and it is used both to encode documents and to serialize data.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively the entire processing system may be self-contained on a single device.

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays, pocket pagers and terminals as well as remote connected computer systems, modems, radio transmitters and handheld personal communication devices such as cellular phones, “smart phones” and digital assistants.

The processing system may also include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein may operate over a network such as the Internet, and may be effectuated using combinations of several processing devices, memories and I/O.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

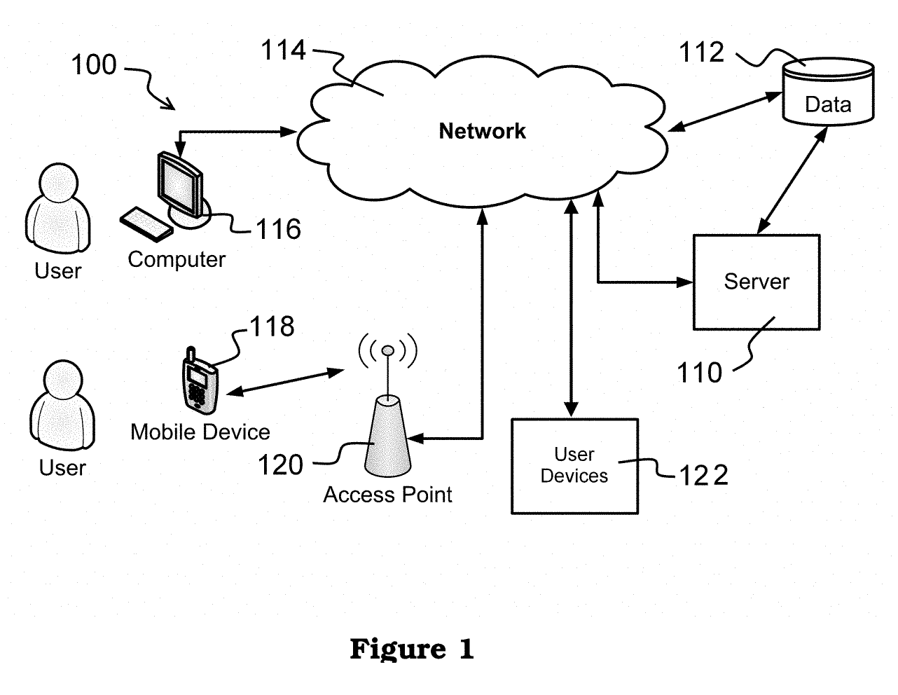

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein a display engine, a data engine, an execution engine, a user interface (UI) engine and the like may be employed. These engines may seek and gather information about events from remote data sources.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

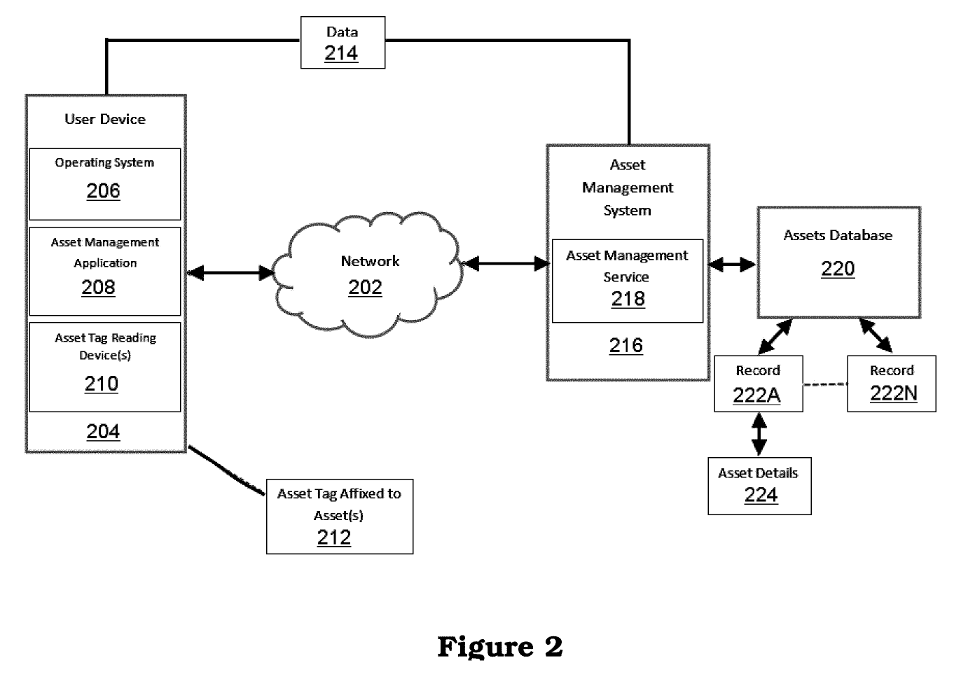

FIG. 2 shows certain aspects of an operating environment for the technologies and embodiments disclosed herein illustrated for inventory optimization and asset selection in an asset management system. The system may be executed over a cloud computing environment (“network”) 202; other forms of distributed computing may also be utilized. The network may be accessed by utilizing a user device 204 to interact with the asset management system. According to various embodiments the functionality of the user device 204 may be provided by one or more cellular phones, mobile telephones, smartphones, server computers, desktop computers, tablet computers, laptop computers, other computing devices and the like. For purposes of describing the concepts and technologies described herein, the user device 204 is a smartphone. It should be understood that this example is merely illustrative and should not be construed as being limiting in any way.

The user device 204 may be effectuated by the use of an operating system 206 which allows the user to interact with one or more installed programs on the user device, like the asset management application 208. The asset management application 208 is an executable program that has been configured to execute on top of the operating system 206 to provide various functionalities of asset management as described herein. It should be understood that the asset management application 208 can be included in other application programs and/or other application programs may be included in the asset management application 208. It therefore can be understood that the one or more application programs and/or the asset management applications 208 can include and/or provide functionality associated with one or more mapping/navigation applications, web browser application, office productivity software, media playback applications, voice and/or other data communication applications and other applications. These applications may be incorporated individually or in any combinations thereof, including all or several of the application programs.

According to various embodiments of the concepts and technologies disclosed herein, the asset management application 208 can be executed on top of the operating system 206 as a stand-alone application. The asset management application 208 may also be executed on a remote system via a web browser on the user device 204. According to various embodiments the asset management system can be used to create, generate, edit, modify and delete various types of asset information in the asset management system as will be explained in detail below.

The user device 204 may include one or more asset tag reading devices. The asset tag reading device 210 can be accessed and/or controlled by the user device to scan and/or otherwise obtain an asset tag affixed to an asset 212 associated with one or more assets. The asset tag reading devices 210 include asset identification devices. According to various embodiments of the concepts and technologies disclosed herein the asset tag affixed to an asset 212 can include a unique identifier tag that can uniquely identify a particular asset, an alphanumeric string that identifies an asset, other information associated with an asset that uniquely identify it, or the like. Thus the asset tag affixed to an asset 212 can include a serial number, a model number, a unique identifier and/or other types of identification information. An asset tag affixed to an asset 212 can present visual indicia to an asset by way of tag, label or the like. To clearly and easily describe the various embodiments of the concepts and technologies described herein, the asset tag affixed to an asset is described as a unique code that can be assigned to an asset. Because other embodiments are possible and contemplated it should be understood that this example is merely illustrative and should not be construed as being limiting in any way.

In some embodiments, the user device 204 can obtain unique asset identification via capturing the information on the asset tag affixed to an asset 212 by using various optical scanning technologies. The asset tag reading device 210 may include a camera or other imaging devices of a user device 204 and the asset tag affixed to an asset 212 can be captured, extracted and/or recognized by way of scanning visual indicia to the asset in the form of the asset tag affixed to an asset 212. According to some embodiments a visual indicia may include one or more types of 1 Dimensional barcode. According to some other embodiments, the visual indicia can include a 2 Dimensional barcode (“2D barcode”) such as a Quick Response Code (QR Code). According to other embodiments, the visual indicia may be in the form of other 2D barcodes such as an EZCODE, an AZTEC Code, a CODABLOCK barcode, and/or other matrix barcodes, various multi-color codes, and the like. According to other embodiments, the visual indicia may be in the form of other types of barcodes such as 3 Dimensional barcodes and PM Codes. These visual indicia may be used individually or be incorporated in any number of combinations thereof. Because the visual indicia can include almost any type of information it must be understood that the examples given are merely illustrative. It is possible and contemplated that there may be other types of visual indicia used, therefore these examples should not be considered to be limiting in any way.

According to various embodiments, the asset tag reading device 210 can interact with the asset tag affixed to an asset 212 by capturing data over various wireless communication channels. As such, the asset tag reading device 210, in some embodiments, can contain identifier capture devices like radio transmitters, infrared transmitters, near field communication (NFC) devices, combinations thereof, or the like. For the purposes of illustration, the asset tag reading device 210 in the technologies and concepts disclosed herein has been identified as a camera. It must be understood that this is only for illustrative purposes, it is by no means considered the only embodiment of the disclosed technologies and concepts, therefore it must not be held to be limiting in any way.

The asset management application 208 may be configured to activate and interact with the asset tag reading device 210 and capture data on the asset tag affixed to an asset 212. The asset management application 208 may further be configured to interact with the asset tag reading device 210 to capture any information related to the asset and/or an entity managing the user device 204. In particular, the asset tag reading device 210 may be configured to interact with various location devices and/or software on the user device 204 such that when an asset tag is scanned and/or captured by the asset tag reading device 214, the geographical location of the asset may also be determined.

The asset management application 208 may also be configured to capture and/or determine time and date information of the scanned asset at the time of the scanning and/or capture of the information asset tag affixed to an asset 212. The asset management application 208 may also be configured to capture other information that includes location information, such as: user credentials, network connection information, device orientation information, temperature information, speed information, pressure information, information from other sensors on the user device, and the like. Accordingly, the user device 204 may have global positioning electronics and software or other location techniques to provide location information.

The user device may capture, bundle and package the information captured and share the data 214 with an asset management system 216, via the asset management application 208. The asset management system 216 can be configured to capture the data 214 by executing an asset management service 218. The asset management service 218 may store the data, modify the data, keep it in a structured data source such as asset database 220 that stores records 222 A-N of the various assets that have been shared via the user device 204. The shared data 214 may be from a multiple incarnations and/or types of the user device, the user device 204 is merely illustrative and the existence of one type in the concepts and technologies disclosed herein does not limit it in any way. The asset management system 216 may include the asset management service 218 which is utilized for optimizing inventory for asset selection based on the factors to be analyzed as discussed above.

The asset management system 216 may be configured to execute the asset management service 218 to interact with the asset database 220 and create, edit, search, modify, delete and/or manipulate the records 222 A-N and asset details 224 contained therein. The asset management system 216 may further be configured to perform any other task pertaining to maintaining and organizing the asset management service along with the asset database 220. The embodiments disclosed herein are merely illustrative and do not limit the functionalities of the asset management system 216 in any way.

The records 222 A-N in the asset database 220 may contain details of each of the various assets. The details may be stored as asset details 224 and be configured to identify, organize and store information about each of the assets in the asset management system 216. The asset details 224 may contain information such as: asset identifier(s) as captured via the asset tag reading device 210 by capturing and/or scanning the asset tag affixed to an asset 212. The asset details 224 may contain other information about the asset such as information about the organization(s), user(s) information, location(s) information, event(s) information, action(s) information, device(s) information, and other information about the asset, the user and/or the user device 204, and the like.

The asset database 220, all the records 222 A-N, the asset details 224 contained therein, and other information may be stored in the form of a structured data store. The functionality of the data store may be provided by one or more server computers, desktop computers, laptop computers, mobile telephones, other computing systems, and the like. The records 222 A-N may be modified, edited, stored and/or deleted on the asset management service 218, based upon the data 214 shared by the user device 204 and/or based upon other information such as creating, editing, modifying and/or deleting the data manually in the asset management service 218 by executing the asset management system 216 over the one or more data store described above, or the like.

Upon receiving information about the asset tag affixed to an asset 212 the asset database 220 may identify the one or more records 222 A-N that may correspond to the asset identifier(s) information captured and/or scanned by the user device 204. The asset management system 216 may display the information to the user device 204 based on the various factors that are to be considered by the asset management service 218, which will be discussed in detail below.

In addition to asset information, a structured data store may include client information allowing a client to be categorized by industry, prior rentals, projected future rentals and the like. For example and without limitation, a renter who puts a lot of “wear and tear” on an asset may be categorized on a relative scale as a heavy user, whereas a light user may have a different relative indicator. Similarly slower payers, or higher risk renters may be relatively categorized as well.

A software engine may be programmed to determine how best to manage assets based on the relative categorization of the client and assets to maximize rental profits or reduce the total cost of ownership for an asset. Moreover a software engine may access information from remote data sources to combine such information as credit history, industry forecasts, projected rainfall, economic growth and the like to effect asset management.

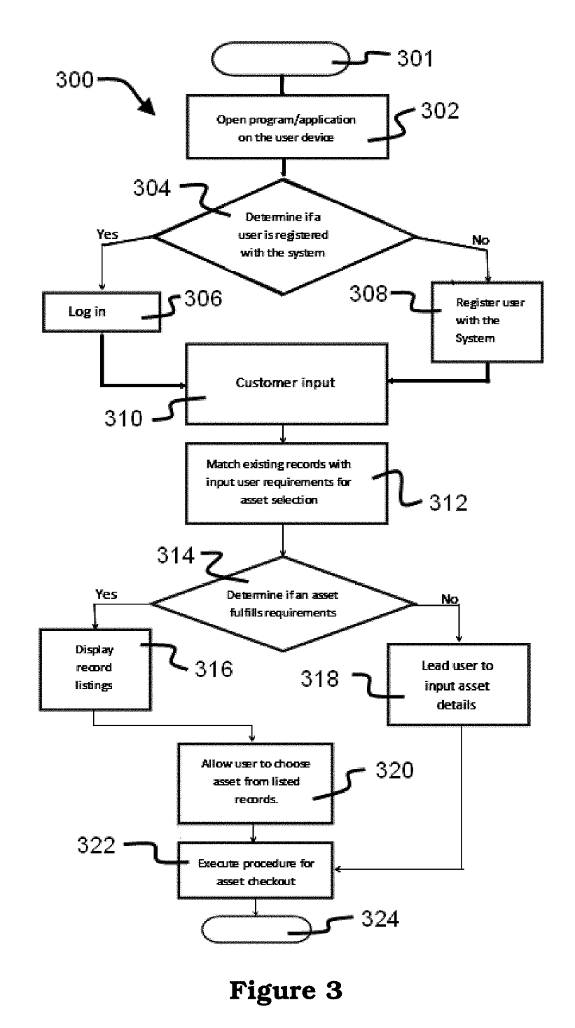

FIG. 3 illustrates of an example embodiment for the online interface method 300 according to the present disclosure. The illustration is to describe customer interaction with the online interface of the system as disclosed herein. It must be noted that the operations of the methods disclosed herein are not necessarily presented in any particular order and that the performance of some or all of the operations in an alternative order(s) is possible and contemplated. The operations have been presented in the demonstrated order for ease of description and illustrations. Operations may be added, omitted and/or performed simultaneously, without departing from the scope of the technologies disclosed herein.

For the purposes of illustrating and describing the concepts of the present disclosure, process 300 is described as being performed by the user device similar to the item 204 above. The method begins at a flow label 301. By employing a user device, a user may interact with the asset management system by launching a computer program and/or an asset management application, as per step 302 on the user device over a cloud computing environment or other similar distributed computing environments. Upon launching a computer program and/or an application 302, the user may be guided by the system to a login screen where, at a step 302 existing user login details 304, may establish either that the user's credentials exist in the system and guide the said user automatically to inside the interface of the system and log in at a step 306 to the computer program and/or an application, or in the case a user is determined not to be already registered with the system, the method 300 will progress to a guided registration process at step 308 that will allow the user to input their credentials and obtain a secure login into the system.

Upon registering the user with the system at step 308 the interaction then proceeds to step 310 where the user is guided to an aspect of the interface where the user may input details, configuration requirements and/or description for the asset requirement they need. The operation of customer input 310 may involve manually specifying customer requirements. The step 310 may also involve accessing the list of all records in an asset database and selecting one of their choice. The asset management system by executing the asset management service will initiate a search function at step 312 and interact with the asset database and upon searching the asset records, will match existing records with the user requirements for asset selection. The process of asset selection is governed by the determination of certain factors disclosed herein. Certain factors may include other factors that allow for determination of the ranking of assets for the user to ensure optimal utilization of all the assets and their multiplicities in the asset database. In addition, assets may be managed by category, such that a particular asset need not be present, but an asset category is presented instead. For example, and without limitation, a customer input might include a category for a tractor, and the asset database may include several types of tractors.

The embodiments discussed herein with regards to the concepts and technologies disclosed herein are for illustrative purposes. There are other factors and embodiments that are possible and contemplated for the optimization of inventory and asset selection may ensure even utilization of all assets and their multiplicities in the asset database, therefore, these embodiments should not be considered to be limiting in any way.

After searching the asset database for matching existing records in step 312 with the user input for asset selection, the method 300 then proceeds to the aspect of determination of fulfillment of user requirements at a step 314. This step determines if an asset fulfills the user requirements as input by the user. Once assured there are indeed assets in the asset database that do fulfill the requisite customer input from step 310, the method 300 will display the record listing at a step 316. The record listing 316 is done by ranking the assets based on the analysis of the factors disclosed herein to ensure optimal utilization of all assets and their multiplicities and appropriate asset selection thereof. The user may then be allowed to choose an asset of their choice, requirements and/or preference from the listed records in step 320. Once the user has made their selection, the method 300 will then proceed to execute procedure for asset checkout in step 322. The checkout process 322 involves notification to the user, the system administrator(s) and any other entity as specified by the administrator and/or user. The checkout process 322 further involves generating a message and subsequently an invoice to the user listing the checkout/rental period allowed to the user, the price/tariff for the duration of the checkout period allowed to the user, the asset details of the asset that has been checked out by the user, any other details that are relevant and/or specified by the administrator of an asset management system.

If the determination of step 314 is that no asset presently in the asset database fulfills the criteria as set by the customer input of step 310, the user will be guided to step 318 where the user may enter custom asset details. The user may then add information about the asset as per their requirements. The information of the asset as custom configured by the user in step 318 may contain asset name, description of the asset, information of the functions of the asset, information of asset model, make, build, any other information pertaining to the asset the user finds appropriate to input in order to, first, find the asset the through a search function performed on the records and upon failure, to determine any matches through this, proceeding to the checkout in step 322.

The method 300 ends at flow label 324.

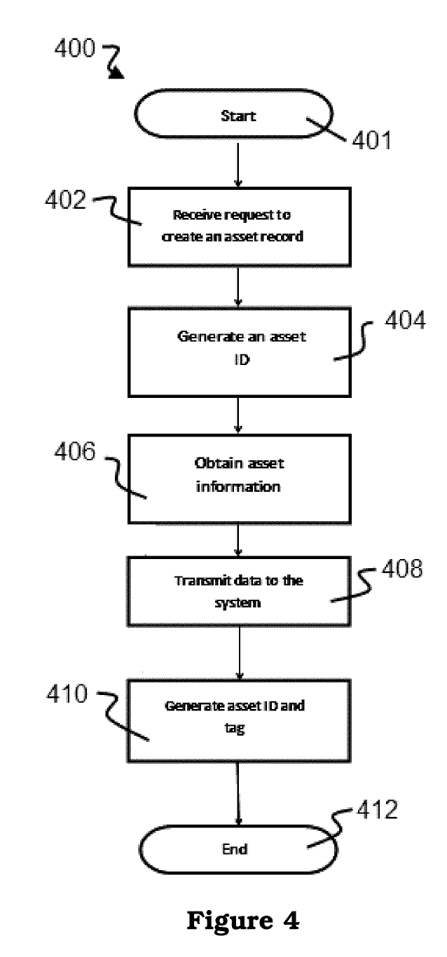

FIG. 4 illustrates certain the aspects of the current disclosure for creating asset information for a system. The operations of methods disclosed herein are not necessarily presented in any particular order and that performance of some or all of the operations is possible and it is contemplated. The operations are disclosed in the demonstrated order for ease of description and illustration. Operations may be added, omitted and/or performed simultaneously, without departing from the scope of the concepts and technologies described herein.

For purposes of illustrating and describing the concepts of the present disclosure, the process 400 is described as being performed by the user device similar to those described earlier via execution of one or more software modules (or engines) such as, for example, the asset management application described above. It should be understood that additional and/or alternative devices and/or network nodes can provide the functionality described herein via execution of one or more modules, applications, and/or other software including, but not limited to, the asset management application. Thus, the illustrated embodiments are illustrative, and should not be viewed as being limiting in any way.

The process 400 begins at a flow label 401. At a step 402 the asset management system receives a request to create an asset record from a user device via an asset management application. The request to create an asset record may be received as input by the user once they have logged into the asset management system by user input in the form of creating additional and/or first record containing asset details as per the user and/or system administrator requirements. The user input into the asset management system may include the preferences and/or requirements with regards to asset utilization such as, asset rental and/or checkout frequency, even usage vis-à-vis multiplicities of the asset, asset depreciation, other relevant information, or the like.

At a step 404 the asset management system generates an asset identification (ID). The asset ID generated may include an asset tag that is to be affixed to an asset. The asset ID may additionally contain information regarding asset details that can include asset model number, make and/or manufacturing information, GUID and/or other similar unique asset identifier information, any other information that the user and/or system administrator deem relevant to be included or the like. The asset tag may be in the form of a label, tag and/or other identifier(s) and contain the asset details in the form of any text, graphic and/or other medium that the user and/or system administrator may choose.

At a step 406 asset information is obtained by the asset management system. The asset management system interacts with the asset database and prompts the user and/or other entity operating the one or more user devices for information associated with the asset. This information associated with the asset may contain information regarding asset location and/or geographic location information of the asset, time and/or date information, information about the current status of the asset, information about and/or specification of personnel authorized to access and/or interact with an asset record, information authentication or credential information, permissions, or the like. The asset information may also include information associated with a customer or final target for the rental of the asset, including, but not limited to: final destination location and/or time or expected time, a date of completion of the asset rental or anticipated date of completion, shipping and/or delivery location information, cost upon completion and/or expected cost upon completion, goal, any combinations thereof, or the like. The examples listed are only illustrative and should not be construed to be limiting in any way.

At a step 408, the user device submits the asset information to the asset management system. Accordingly, the user device may be configured to package the asset information as data and/or to stream information to the asset management system or otherwise make the data available to an asset management engine.

At a step 410, the user device generates one or more asset ID tags, labels, or other indicia that include information identifying the asset tag affixed to an asset. In some embodiments, the user device can be configured to send a print request to a printer to generate the asset ID tag or label. In some other embodiments, the user device can be connected to a printer via a wired and/or wireless connection. Thus, operation can correspond, in some embodiments, to printing or requesting printing of a label or tag that represents the asset identification information generated in step 404. In one contemplated embodiment, the asset label or tag includes a QR code that represents the asset tag affixed to an asset. Because other indicia are contemplated and are possible, it should be understood that this embodiment is illustrative, and should not be construed as being limiting in any way. Example user interfaces that support printing or other generation of asset tags, bar codes, labels, or other indicia.

The process ends at a flow label 412.

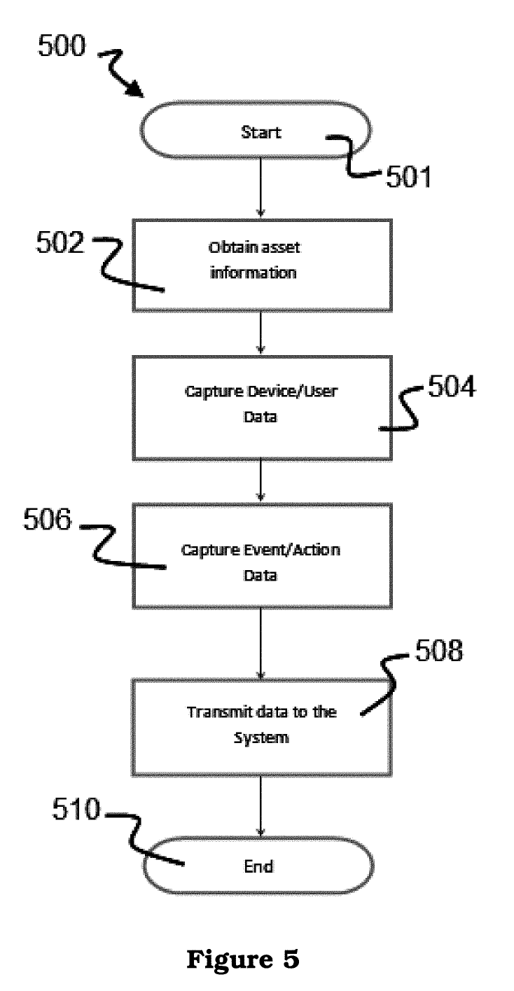

FIG. 5 shows a process 500 illustrating certain aspects of updating asset information for inventory optimization for an asset management system. The process 500 is described as being performed by the user device similar to those described herein via execution of one or more software modules such as, for example, the asset management application. It should be understood that additional and/or alternative devices and/or network nodes can provide the functionality described herein via execution of one or more modules, applications, and/or other software including, but not limited to, the asset management application. Thus, the illustrated embodiments are illustrative, and should not be viewed as being limiting in any way.

The process 500 begins at a flow label 501.

At a step 502 the asset management system obtains asset information from a user device being operated by a user and/or other entity. The asset information obtained by the asset management system may correspond to a user scanning or otherwise capturing an asset tag affixed to an asset. In some embodiments, the asset tag affixed to an asset can be scanned or captured from an asset tag, label, or other indicia. In some embodiments, the asset tag information can be input as text by a user or other entity. In yet other embodiments, a graphic, voice command, or other type of data can be obtained in operation 502. This embodiment is illustrative, and should not be construed as being limiting in any way.

At a step 504 wherein the user device captures device and/or user data. According to various embodiments, the user device can be configured to capture various data when the asset tag affixed to an asset is captured and/or at other times. The device/user data can include, for example, a time and/or date; a geographic location and/or other location information such as network identifiers, location within a building or other structure, or the like; sensor data or information such as temperature, light, noise levels, or the like; device identifiers such as International Mobile Station Equipment Identity (IMEI), International Mobile Subscriber identity (IMSI), unique device identifier (UDID), serial numbers, or the like; user identifiers such as name, identification numbers, authentication information, passwords, tokens, user IDs, or the like; other information; and/or combinations thereof.

At a step 506 the asset management system may capture event and/or action data to be accorded to the one or more assets as previously specified by the user. The event and/or asset information can be selected from a list of events or actions. The list of events or actions can be delivered to or otherwise obtained by the user device from the asset management system. The events or actions may be determined and/or based upon the information received from the asset tag affixed to an asset obtained in step 502, as well as the device/user data obtained in step 504. In some embodiments, the event and/or action information can be generated at the user device and therefore may or may not be represented in a list of events or action. The event/and or action may include, but not be limited to: specifying rental date and time, specifying rental customer names, specifying return date and/or time or expected return date and/or time, any other information that the user and/or system administrator may identify, any combinations thereof. The event and/or action data 506 may also include specifying asset selection information for optimization of inventory including, but not limited to, specifying the preferences and/or requirements with regards to asset utilization such as, asset rental and/or checkout frequency, even usage vis-à-vis multiplicities of the asset, asset depreciation, other relevant information, or the like.

At a step 508 data captured about the device from step 504 and the event/action data captured 506 is transferred to the asset management system or directly to the asset management service. According to some embodiments, the data transmitted in step 508 may include, but is not limited to, the asset identification information obtained from the asset tag affixed to an asset, the device/user data, and event information captured and/or obtained in steps 502-506. The data and/or other types of event data or other information captured in step 502-506 may include the types of information listed above as well as location information, user information, sensor readings, device information, time information, and asset actions. The asset actions can include, but are not limited to, specific actions or events such as, for example, repaired, visited, delivered, commenced, received, in progress, pending, or the like.

The process 500 ends at a flow label 510.

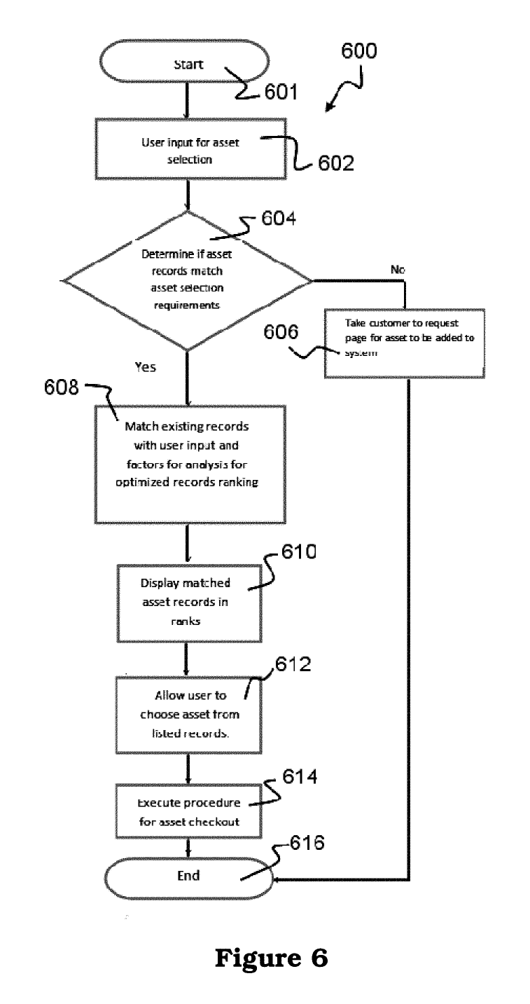

FIG. 6 shows a process 600 which depicts optimization of inventory for asset selection based on the current disclosure. The process 600 begins at a flow label 601.

At a step 602 the user, having already logged into the system, inputs their requirements to select an asset. The user input includes selection of asset details for the number of asset records contained in the asset database. The user input further includes specification of factors for analysis for optimization of inventory. By way of example only, some of the factors to be analyzed may include:
analyzing data of asset details contained in the records within the asset database
availability of asset
Location of asset
availability of the asset utilization of the multiplicity of an asset depreciation of an asset
user relevance of an asset
frequency of rental and/or checkout of assets carried out by users, and
ranking of relevant assets based on user's past association, preferences and asset selection history in the system.

There are other factors and embodiments that are possible and contemplated for the optimization of inventory and asset selection to ensure even utilization of all assets and their multiplicities in the asset database, therefore, these examples should not be considered to be limiting in any way.

At a step 604 the asset management system determines which, if any, existing records match the user input requirements for asset selection. Upon determination if there are no records that match user requirements, the system directs the user at step 606 to a ‘request page’ to request that the system administrator acquire a particular asset.

If, the asset management system determines that there are matching records for the user input requirements the method proceeds to a step 608 wherein the asset management system matches existing records that comply with user requirements with the factors of optimization of inventory as specified by the user above.

At a step 610 the asset management system prompts the asset management service to display the list of records that match the analysis, ranking them with the most compliant with the requirements appearing first, and providing rental cost information. The display is made to the user within the asset management application and/or program on a user device.

At a step 612 the user may choose an asset that meets their requirements from the listed records. Once the user has made a selection, the process will proceed to a step 614 for asset checkout 614. The checkout process of step 614 involves notification to the user, the system administrator(s) and any other entity as specified by the administrator and/or user. The checkout process step 614 further involves generating a message and subsequently an invoice to the user listing the checkout/rental period allowed to the user, the price/tariff for the duration of the checkout period allowed to the user, the asset details of the asset that has been checked out by the user, any other details that are relevant and/or specified by the administrator of the asset management system.

The process 600 ends at a flow label 616.

### Operations

One of the effects of the current disclosure is to provide improved performance of asset management industries. For example and without limitation, the owner of the assets may make those assets available for sale or rent based upon the useful life of the asset. This allows asset managers to rotate their stock by providing to renters or purchasers assets nearing their useful lives. In addition, the asset manager may set pricing based on useful life of the asset to accelerate or decelerate the asset usage. This allows asset manager to manage future cash flows by shifting replacement times for the assets or synchronizing expenses to better conform to depreciation amounts under various tax regimes.

Another benefit to the present disclosure is that is provides for asset allocation for seasonal demands. For example and without limitation, seasonal use of an asset may be tracked and forecasted by geography and industry. An asset manager may them position assets to minimize transportation costs and provide price incentives to maximized revenue on a seasonal basis.

Another commercial benefit of the present disclosure is the ability to measure and project service requirements for assets as they move through there economically viable life. For example and without limitation and asset that will soon require major servicing may be offered to a renter at a specific time and location that is beneficial to the asset manager. For example and airplane may be offered to a renter at a discount if the renter will use or return the airplane to an airport more conducive to doing repairs or maintenance.

Another advantage to the current is disclosure is that is allows a user to evaluate asset attributes including depreciation, age, total cost of ownership (TCO), maintenance spent, and/or other custom attributes of an asset recorded in an asset management database to determine:
user relevance to an asset in the said asset records in an asset management database;
asset rental and/or checkout frequency;
ranking of relevant assets based on user's past association, preferences and asset selection history in the system;
externalities like weather or other inputs from external systems such as manufacturer alerts, vendor financial risks etc.
   Once determined, asset allocation may be optimized to reduce the cost of asset ownership or rental operations.

In yet another advantage to the current disclosure is a system where a user's record of rental, seasonal activity, and care of assets may be leveraged to provide a more economically viable service. For example and without limitation, a user John wants to rent a tractor for 2 months. John is located in Arizona and its summer (so hot weather is expected). John is a frequent renter and has a history of wearing out what ever he rents. The asset manager has some new tractors and a few old ones in stock. Since its summer, renting the really old tractors might cause them to break down in the summer heat, but renting the brand new ones will cause them to degrade (and be classified as heavily used) very quickly. With an asset management system John would be recognized as a valuable client based on his sustained business and future potential, and offered a new tractor. However, in cooler seasons he may be offered the oldest tractor in the warehouse.

Similarly a less frequent renter may be offered a more heavily used tractor because the economic damage to the asset manager is minimized.

### Pricing

In some embodiments pricing may be controlled by the asset attributes. for example and without limitation, rental pricing may be inversely proportional to the age or expected lifetime of the asset. A new asset may be offered to a potential renter for a higher price. Similarly, a slow payer may pay a premium on the rental rate. Relative relationships may be used to effectuate a base price, thus creating s sliding scale price which varies with asset and customer attributes.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A method including:
receiving at a server, said server coupled to a network, asset information, said asset information including an asset age, expected asset lifetime, rental history, asset location and asset availability information;
receiving at said server a rental request from a user, said rental request including identification of at least one asset category;
receiving at the server user information, said user information including user location and rental time information;
determining one or more assets in the asset category in response to the user information and rental request, and
presenting a list of assets and a rental price to the user as a result of said determining.

2. The method of claim 1 wherein said determining includes comparing the expected asset lifetime with the rental time information.

3. The method of claim 1 wherein the rental price is responsive to the expected asset lifetime.

4. The method of claim 1 wherein the list of assets is prioritized to optimize asset allocation by reducing cost of asset ownership.

5. The method of claim 1 wherein the list of assets is prioritized to optimize asset allocation by reducing the cost of servicing the rental request.

6. A method including:
maintaining, at a server, asset records and communicating operationally dependent information of the asset records and importing said operationally dependent information of the asset records to an asset management database;
displaying asset records upon receiving user requirements input, said user remotely coupled to the server over a network;
ranking said asset records and displaying, to the user, the matching records, said ranking customized to minimize total cost of ownership.

7. The system of claim 6, wherein the ranking of said asset records and displaying, to the user, the matching records is effectuated by analysis of the factors for inventory optimization.

8. The system of claim 7, wherein analysis of the factors for inventory optimization includes analyzing at least one of asset status, asset location, asset age, or asset depreciation.

9. The system of claim 7, wherein analysis of the factors for inventory optimization includes analyzing at least one of total cost of ownership or maintenance expenditures.

10. The system of claim 7, wherein analysis of the factors for inventory optimization includes analyzing at least one of the user's prior rental of similar assets.

11. The system of claim 7, wherein analysis of the factors for inventory optimization includes analyzing network inputs from external systems, said inputs including manufacturer alerts and vendor financial risks.

12. One or more processor readable storage devices having non-transitory processor readable code embodied on said processor readable storage devices, said processor readable code operable for programming one or more processors to perform a method including the steps of:
receiving at asset information, said asset information including an asset age, expected asset lifetime, rental history, asset location and asset availability information;
receiving a rental request from a user, said rental request including identification of at least one asset category;
receiving user information, said user information including user location and rental time information;
determining one or more assets in the asset category in response to the user information and rental request, and
transmitting a list of assets and a rental price to the user as a result of said determining.

13. The device of claim 12 wherein said determining includes comparing the expected asset lifetime with the rental time information.

14. The device of claim 12 wherein the rental price is responsive to the expected asset lifetime.

15. The device of claim 2 wherein the list of assets is prioritized to optimize asset allocation by reducing cost of asset ownership.
